(19) United States
(12) Patent Application Publication
(10) Pub. No.: US 2011/0230625 A1
(43) Pub. Date: Sep. 22, 2011

(54) FLAME-RETARDANT POLYESTER RESIN COMPOSITION

(75) Inventors: Yasuo KURACHI, Tokyo (JP); Akira OHIRA, Tokyo (JP); Hiroshi ONO, Aichi (JP); Kazuyoshi OTA, Aichi (JP)

(73) Assignee: KONICA MINOLTA BUSINESS TECHNOLOGIES, INC., Tokyo (JP)

(21) Appl. No.: 13/047,078

(22) Filed: Mar. 14, 2011

(30) Foreign Application Priority Data
Mar. 18, 2010 (JP) 2010-062065

(51) Int. Cl. C08L 67/02; C08L 69/00

(52) U.S. Cl. 525/439

(57) ABSTRACT

Provide is a flame-retardant polyester resin composition exhibiting excellent flame-retardant performance, specifically flame self-extinction performance and excellent mechanical performance such as elastic modulus, bending strength, and impact strength. Also provided is a flame-retardant polyester resin composition exhibiting excellent flame-retardant performance, specifically flame self-extinction performance and excellent mechanical performance such as elastic modulus, bending strength, and impact strength, even when at least one of a polyester resin and a polycarbonate resin obtained from molded products having become waste materials is recycled. A flame-retardant polyester resin composition comprising: (A) 50-80% by mass of a polyethylene terephthalate (PET), (B) 5-40% by mass of a polycarbonate resin, (C) 5-30% by mass of a polymer of a glass transition temperature Tg of less than 35° C., (D) 0.5-5% by mass of a polymer of a carbon residue rate resin of at least 15%, and (E) 1-10% by mass of a polyethylene naphthalate (PEN).

This application is based on Japanese Patent Application No. 2010-062065 filed on Mar. 18, 2010, in Japanese Patent Office, the entire content of which is hereby incorporated by reference.

### TECHNICAL MELD

The present invention relates to a flame-retardant polyester resin composition which is injection-moldable. Further, the present invention relates to a recycling technology for a molded product of a thermoplastic resin having become a waste material.

### BACKGROUND

In view of excellent molding processability, mechanical physical properties, heat resistance, weather resistance, appearance properties, hygienic properties, and economic efficiency, currently, thermoplastic resins such as polyester resins or polycarbonate resins and resin compositions thereof are being used in a wide variety of fields as molding materials for containers, wrapping film, household groceries, office equipment, audio-visual equipment, electric/electronic components, and automobile components. Thereby, the used amounts of molded products of such thermoplastic resins and resin compositions thereof are large and still increasing year by year. On the other hand, the amount of molded products, which was used and then became unnecessary, resulting in being disposed of, is more and more increasing, which results in serious social issues.

In such a background as described above, over recent years, laws such as “The Containers and Packaging Recycling Law” and “The Law Concerning the Promotion of Procurement of Eco-Friendly Goods and Services by the State and Other Entities” (commonly known as “The Law on Promoting Green Purchasing”) are being put into effect one after another. Thereby, attention to material recycling of molded products of such thermoplastic resins and resin compositions thereof is increasing. Of these, urgent is the establishment of the material recycling technology of PET bottles, whose material is polyethylene terephthalate (hereinafter referred to also as PET), the amount of which is rapidly increasing. Further, with the popularization of optical recording media products (optical disks) such as CDs, CD-Rs, DVDs, or MDs, whose material is polycarbonate (hereinafter referred to also as PC), recycling methods of remnant materials generated during molding processing and investigations to recycle transparent PC materials obtained after separating the reflective layer and the recording layer from an optical disk which has become a waste material are now in progress.

However, molded products of polyester resins such as used PET bottles and of polycarbonate resins such as used optical disks having been recycled from the market have been frequently degraded due to hydrolysis or thermal decomposition. For example, even when those obtained by pulverizing such molded products are intended to be molded again, due to a marked decrease in melt viscosity, no molding is carried out at all or even if molding can be carried out, mechanical strength is poor, resulting in easy breakage. Thereby, the situation is that recycling use for molded products which can be put to practical use is extremely difficult.

As methods to collect recycling resins from discarded molded products, for example, a method for melt-kneading of pulverized pieces of molded products of thermoplastic resins such as PET or PC or resin compositions thereof with an epoxy group-containing ethylene copolymer (Patent Documents 1 and 2) and a method for melt-kneading of an epoxidized diene-based copolymer (Patent Document 3) are proposed. Further, Patent Documents 4-7 propose a material technology in which to improve the impact strength of R-PET (recycled PET), a rubber-like polymer is combined. However, in these well-known technologies, poor appearance occurs due to the slow crystallization rate of PET, and injection molding is difficult to carry out due to small melt viscosity. Or, to achieve enhanced fire protection performance, a flame retardant containing a halogen atom is used. However, addition of such a flame retardant containing a halogen atom has made it impossible to sufficiently improve impact strength. Therefore, when the added amount of such a flame retardant containing a halogen atom is reduced, flame-retardant performance trouble may occur, which thereby has become an obstacle to application expansion. In addition, the flame retardant containing a halogen atom has produced safety problems against the environment and human body due to the halogen atom.

### PRIOR ART DOCUMENTS

### Patent Documents

[Patent Document 1] Unexamined Japanese Patent Application Publication (hereinafter referred to as JP-A) No. 5-247328
[Patent Document 2] JP-A No. 6-298991
[Patent Document 3] JP-A No. 8-245756
[Patent Document 4] JP-A No. 2003-183486
[Patent Document 5] JP-A No. 2003-213112
[Patent Document 6] JP-A No. 2003-221498
[Patent Document 7] JP-A No. 2003-231796

### SUMMARY OF THE INVENTION

In view of the above circumstances, initially, the present inventors conducted diligent investigations on a practicable recycling method for pulverized articles of PET bottles which are typical polyester resin-made recycling materials and further conducted additional investigations on a utilization method of pulverized articles of polycarbonate resin-made optical disks. Thereby, it was found that a resin composition containing predetermined (A)-(E) components in combination exhibited excellent mechanical performance and also expressed flame self-extinction performance in air. Further, it was found out that such effects were produced not only in cases in which PET bottle-pulverized articles and PC optical disk-pulverized articles were used, but also in cases in which common virgin PET and PC were used. Thus, the present invention was completed.

An object of the present invention is to provide a flame-retardant polyester resin composition exhibiting excellent flame-retardant performance, specifically flame self-extinction performance even with no inclusion of a halogen atom-containing flame retardant and also exhibiting excellent mechanical performance such as elastic modulus, bending strength, and impact strength.

The present invention is also intended to provide a flame-retardant polyester resin composition exhibiting excellent flame-retardant performance, specifically flame self-extinction performance even with no inclusion of a halogen atom-containing flame retardant and also exhibiting excellent mechanical performance such as elastic modulus, bending strength, and impact strength, even when at least one of a polyester resin and a polycarbonate resin obtained from molded products having become waste materials is recycled.

The present invention is an invention relating to a flame-retardant polyester resin composition containing the following resin components (A)-(E): (A) 50-80% by mass of polyethylene terephthalate (PET), (B) 5-40% by mass of a polycarbonate resin, (C) 5-30% by mass of a polymer of a glass transition temperature Tg of less than 35° C., (D) 0.5-5% by mass of a polymer of a carbon residue rate of at least 15%, and (E) 1-10% by mass of polyethylene naphthalate (PEN).

Herein, in the present invention, “-” is shown to include both end numerical values. Namely, “50-80% by mass” represents “a range from at least 50% by mass to at most 80% by mass.”

When a flame-retardant polyester resin composition of the present invention and the above resin composition are used, an injection molded body exhibiting excellent appearance is obtained, and even with no inclusion of a halogen atom-containing flame retardant, excellent flame-retardant performance, specifically flame self-extinction performance is exhibited and also excellent mechanical performance such as elastic modulus, bending strength, and impact strength are expressed. Such effects can be also produced in cases in which at least one of a polyester resin and a polycarbonate resin obtained from molded products having become waste materials is recycled.

When produced via a predetermined gap passing treatment, the flame-retardant polyester resin composition of the present invention exhibits enhanced flame self-extinction performance and mechanical performance such as elastic modulus, bending strength, and impact strength, and specifically exhibits extremely enhanced flame self-extinction performance.

### BRIEF DESCRIPTION OF THE DRAWINGS

FIG. 1A is a schematic perspective view of one example of an apparatus to produce the flame-retardant polyester resin composition of the present invention when the interior of the apparatus is seen through from the top and FIG. 1B is a schematic cross-sectional view at the P-Q cross-section of the apparatus of FIG. 1A;

FIG. 2A is a schematic perspective view of one example of an apparatus to produce the flame-retardant polyester resin composition of the present invention when the interior of the apparatus is seen through from the top and FIG. 2B is a schematic cross-sectional view at the P-Q cross-section of the apparatus of FIG. 2A;

FIG. 3A is a schematic perspective view of one example of an apparatus to produce the flame-retardant polyester resin composition of the present invention when the interior of the apparatus is seen through from the top and FIG. 3B is a schematic cross-sectional view at the P-Q cross-section of the apparatus of FIG. 3A; and

FIG. 4A is a schematic sketch of one example of an apparatus to produce the flame-retardant polyester resin composition of the present invention and FIG. 3B is a schematic cross-sectional view at the P-Q cross-section passing through the axis of the apparatus of FIG. 4A.

### DESCRIPTION OF THE PREFERRED EMBODIMENT

[(A) Component]

A (A) component blended in the flame-retardant polyester resin composition (hereinafter referred to also as the resin composition) of the present invention is polyethylene terephthalate (hereinafter referred to also as PET).

The inherent viscosity of a polyester resin is not specifically limited, being, however, preferably in the rage of 0.50-1.50 dl/g, more preferably 0.65-1.30 dl/g in the present invention. When the inherent viscosity is excessively small, inadequate impact resistance is realized and also chemical resistance may be degraded. In contrast, when the inherent viscosity is excessively large, fluid viscosity is increased and then high kneading temperature needs to be set, whereby kneading is carried out at an unfavorable temperature for other combined additives.

In the present specification, the inherent viscosity is a value obtained via determination at 30° C. using a phenol/tetrachloroethane (mass ratio: 1/1) mixed solvent.

Such a polyester resin commonly has a melting point of 180-300° C., preferably 220-290° C. and a glass transition temperature Tg of 50-180° C., preferably 60-150° C.

In the present specification, the melting point refers to the end-point temperature of a crystal melting endothermic peak appearing during rising temperature determination using a differential scanning colorimeter (DSC).

The glass transition temperature Tg refers to the temperature of a portion in which the baseline is varied in a stepwise manner in the same determination as for the melting temperature. For details, in the same determination as for the melting temperature, the glass transition temperature Tg is the temperature of a point in which a straight line which is equally distant, in the vertical direction, from a straight line extending from each baseline before and after a portion stepwise varied and a curve of the stepwise varied portion intersect.

As a polyester resin, resin pieces obtained by pulverizing discarded polyester resin products are employable. Especially, as PET having an inherent viscosity of the above range, pulverized articles of PET products such as used and discarded PET bottles can be suitably used. Usable are resin pieces obtained via appropriate size pulverization of bottles, sheets, and clothing which are PET products collected as waste materials, as well as molding wastes and fiber wastes generated during molding of these molded articles. Of these, pulverized articles of drinking bottles whose amount is large are suitably usable. In general, PET bottles are separated and collected and thereafter, passed through a foreign material removal, a pulverization, and a washing step to be recycled as transparent clear flakes of a size of 5-10 mm. The inherent viscosity of such clear flakes is commonly in the range of about 0.60-0.80 dl/g.

Using discarded polyester resin products, polyester resin pieces can be obtained via pulverization and washing, and then temporal kneading at a temperature of 180° C.-less than 260° C., followed by cooling/pulverization.

Virgin polyester resins are commercially available in the pellet shape. These are pressed at the glass transition temperature or more, or temporarily melted using an extruder and the resulting melted strands are flattened by being passed through rollers in cooled water, followed by cutting using a common pelletizer to be used as resin pieces.

Use of polyester resins as resin pieces makes it easy to carry out supply to a kneader during production of a resin composition, and in kneading until resulting in melting, the load against the kneader is reduced. As the shape of a polyester resin piece, for example, a flake, a block, a powder, or a pellet shape is preferable. The flake shape is specifically preferable. The maximum length of a resin piece is preferably at most 30 mm, more preferably at most 20 mm, still more preferably at most 10 mm. Even when resin pieces having a maximum length of more than 30 mm are contained, kneading can be carried out, but such a case is unfavorable since clogging tends to occur in the supply step. However, if the supply apparatus is improved, such a phenomenon can be prevented. Therefore, the above size is not specifically limited, provided that the object of the present invention is not destroyed.

The blending amount of a (A) component is 50-80% by mass based on the total composition amount, but preferably 50-75% by mass from the viewpoint of further enhancing flame retardant performance and mechanical performance. When the blending amount of the (A) component is excessively small, the dispersion state of other components are changed, whereby mechanical characteristics, specifically impact strength and bending strength are decreased. When the blending amount is excessively large, flame-retardant performance decreases and then flame self-extinction performance disappears, whereby the object of the present invention cannot be achieved. Further, mechanical characteristics, specifically impact strength is degraded.

[(B) Component]

The (B) component includes a polycarbonate resin and an aromatic carbonate obtained via reaction of a divalent phenol and a carbonate precursor. As the production method thereof, any appropriate production method is employable. There are known, for example, a method in which a carbonate precursor such as phosgene is allowed to directly react with a divalent phenol (an interfacial polymerization method) and a method in which transesterification reaction is carried out between a divalent phenol and a carbonate precursor such as diphenyl carbonate in the melt state (a solution method).

Such a divalent phenol includes hydroquinone, resorcin, dihydroxyphenyl, bis(hydroxyphenyl)alkanes, bis(hydroxyphenyl)cycloalkanes, bis(hydroxyphenyl)sulfide, bis(hydroxyphenyl)ether, bis(hydroxyphenyl)ketone, bis(hydroxyphenyl)sulfone, bis(hydroxyphenyl)sulfoxide, bis(hydroxyphenyl)benzene, and derivatives thereof having an alkyl group or a halogen atom substituent on the nucleus. Typical examples of a specifically suitable divalent phenol include 2,2-bis(4-hydroxyphenyl)propane (commonly known as bisphenol A), 2,2-bis{(4-hydroxy-3-methyl)phenyl}propane, 2,2-bis{(3,5-bibromo-4-hydroxy)phenyl}propane, 2,2-bis(4-hydroxyphenyl)butane, 1,1-bis(4-hydroxyphenyl)cyclohexane, 1,1-bis(4-hydroxyphenyl)-3,3,5-trimethylcyclohexane, 4,4′-dihydroxydiphenylsulfone, and bis{(3,5-dimethyl-4-hydroxy)phenyl}sulfone. These can be used individually or in combination of at least 2 kinds. Of these, bisphenol A is specifically preferably used.

The carbonate precursor includes diaryl carbonates such as diphenyl carbonate, ditoluoyl carbonate, or bis(chlorophenyl)carbonate; dialkyl carbonates such as dimethyl carbonate or diethyl carbonate; carbonyl halides such as phosgene; and haloformates such as dihaloformates of divalent phenols with no limitation. Diphenyl carbonates are preferably used. These carbonate precursors may be also used individually or in combination of at least 2 kinds.

The polycarbonate resin may be a branched polycarbonate resin in which multifunctional aromatic compounds having at least 3 functional groups such as, for example, 1,1,1-tris(4-hycroxyphenyl)ethane and 1,1,1-tris(3,5-dimethyl-4-hydroxyphenyl)ethane are copolymerized; or a polyester carbonate resin in which difunctional aromatic or aliphatic carbonic acids are copolymerized. Further, a mixed material, in which at least 2 kinds of obtained carbonate resins are mixed, may be employed.

The molecular weight of a polycarbonate resin is commonly about 1×10⁴-1×10⁵ in terms of viscosity average molecular weight. However, the viscosity average molecular weight of a polycarbonate resin used in the present invention is preferably about 10,000-40,000, more preferably 12,000-35,000.

In the present specification, the viscosity average molecular weight is a value determined using CBM-20A lite system and GPC software (produced by Shimadzu Corp.).

The glass transition temperature of the polycarbonate resin is commonly 120-290° C., preferably 140-270° C.

As a polycarbonate resin, resin pieces obtained by pulverizing discarded polycarbonate resin products are usable. Especially as a polycarbonate falling within the above molecular weight, pulverized articles of discarded optical disks are suitably usable. Resin pieces, in which remnant materials generated during molding processing of optical disks such as CDs, CD-Rs, DVDs, or MDs, and optical lenses, or those obtained by separating the reflective layer and the recording layer from discarded optical disks are pulverized to an appropriate size of at most 10 mm, can be used in the present invention with no specific limitation. Generally, these optical disk polycarbonate resins are of a high fluidity type and those having a small molecular weight of 13,000-18,000 are being used.

Polycarbonate resin pieces of discarded polycarbonate resin products can be also obtained via pulverization and washing and then temporal kneading at a temperature of 180-less than 260° C., followed by cooling/pulverization.

Virgin polycarbonate resins are commercially available in the pellet form. These are pressed at the glass transition temperature or more, or temporarily melted using an extruder and the resulting melted strands are flattened by being passed through rollers in cooled water, followed by cutting using a common pelletizer to be used as resin pieces.

Use of polycarbonate resins as resin pieces makes it easy to carry out supply to a kneader during production of a resin composition, and in kneading until resulting in melting, the load against the kneader is reduced. As the shape of a polycarbonate resin piece, for example, a flake, a block, a powder, or a pellet shape is preferable. The flake shape is specifically preferable. The maximum length of a resin piece is preferably at most 30 mm, more preferably at most 20 mm, still more preferably at most 10 mm. Even when resin pieces having a maximum length of more than 30 mm are contained, kneading can be carried out, but such a case is unfavorable since clogging tends to occur in the supply step. However, if the supply apparatus is improved, such a phenomenon can be prevented. Therefore, the above size is not specifically limited, provided that the object of the present invention is not destroyed.

The blending amount of a (B) component is 5-40% by mass based on the total composition amount, but preferably 10-30% by mass from the viewpoint of further enhancing elastic modulus and flame-retardant performance. When the blending amount of the (B) component is excessively small, flame-retardant performance is decreased and no flame self-extinction is expressed, and further mechanical characteristics, specifically bending strength is degraded. When the blending amount is excessively large, mechanical characteristics, specifically impact strength is degraded. At least 2 types of polycarbonate resins may be used in combination. In this case, the total blending amount of (B) components is allowed to fall within the above range.

[(C) Component]

As a (C) component, a polymer having a glass transition temperature Tg of less than 35° C. is added. One typical example thereof is polyvinyl acetate (Tg: 30° C.). Herein, the glass transition temperature Tg is a value determined using differential thermal scanning colorimetry (DSC). Some polymers may have at least 2 kinds of glass transition temperature Tg. When at least one glass transition temperature Tg of less than 35° C. is observed by DSC, such polymers can be used in the present invention. Rubber-like polymers are most preferable for the component. However, copolymers of rubber-like polymers and resins are also usable.

A polymer having at least one glass transition temperature Tg in the range of less than 35° C. will now be described.

The polymer of the present invention is a necessary component to provide impact resistance for the resin composition of the present invention. Also, usable are rubber-like polymers described in “Gomu Gijutsu Nyumon (An Introduction to Rubber Technology)” (edited by the Society of Rubber Industry, Japan, published by Maruzen Co., Ltd.) and “Netsukasosei Erasutomah No Zairyo Sekkei To Seikei Kakoh (Material Design and Molding Processing of Thermoplastic Elastomers)” (supervised by Shinzo Yamashita, published by Technical Information Institute Co., Ltd.).

A rubber-like polymer refers to a polymer having at least one glass transition point Tg in the range of at most 20° C.

When the number average molecular weight of a rubber-like polymer is excessively small, mechanical properties such as the strength on breakage of the polymer itself and the elongation degree are decreased, resulting in the possibility of a decrease in strength when employed for a composition. Further, in the case of an excessive large value, processability is degraded and then a composition exhibiting adequate performance may not be obtained. Therefore, the number average molecular weight is preferably in the range of 30,000-500,000, more preferably 50,000-300,000.

As such a rubber-like polymer, for example, conjugated diene-based rubber, urethane rubber (UR), and silicone rubber are usable.

Conjugated diene rubber is homopolymer or copolymer rubber containing a conjugated diene-based monomer. The content of the conjugated diene-based monomer is commonly at least 10% by mass, preferably 10-50% by mass based on the total monomer component content.

Specific examples of the conjugated diene-based rubber include, for example, natural rubber, polybutadiene rubber (BR), butadiene-styrene copolymer rubber (SBR), polyisoprene rubber (IR), butadiene-acrylonitrile copolymer rubber, ethylene-propylene-(diene methylene) copolymer rubber (EPDM), isobutylene-isoprene copolymer rubber (IIR), styrene-butadiene-styrene copolymer rubber, styrene-butadiene-styrene radial teleblock copolymer rubber, styrene-isoprene-styrene copolymer rubber, and polychloroprene (CR). Of these specific examples, the copolymer rubber collectively refers to graft copolymer rubber and block copolymer rubber.

As examples of urethane rubber (UR), for example, polyether-based UR and polyester-based UR are cited as a soft segment exhibiting rubber-like characteristics.

As specific examples of silicone rubber, for example, millable-type silicone rubber and LIMS-type silicone rubber are cited. Of these, a millable-type silicone rubber having a cross-linking group is preferable for the present invention. However, even LIMS-type silicone rubber is usable provided that the rubber is obtained by pulverizing rubber produced via cross-linking reaction.

A rubber-like polymer made from one kind of monomer such as, for example, polydimethyl silicone rubber being a type of silicone rubber, natural rubber, polybutadiene rubber (BR), polyisoprene rubber (IR), or polychloroprene rubber (CR) has only one glass transition temperature Tg, and the glass transition temperature Tg is at most 20° C.

Further, a thermoplastic elastomer such as urethane rubber and graft copolymer rubber made from at least 2 kinds of monomers such as, for example, butadiene-styrene graft copolymer rubber (SBR), butadiene-acrylonitrile graft copolymer rubber, ethylene-propylene-(diene methylene) graft copolymer rubber (EPDM), isobutylene-isoprene graft copolymer rubber (IM), styrene-butadiene-styrene graft copolymer rubber, styrene-butadiene-styrene radial teleblock graft copolymer rubber, or styrene-isoprene-styrene graft copolymer rubber have only one glass transition temperature Tg, and the glass transition temperature Tg is at most 20° C.

Further, a block copolymer rubber made from at least 2 kinds of monomers such as, for example, styrene-butadiene-styrene block copolymer rubber, styrene-butadiene-styrene radial teleblock copolymer rubber, styrene-isoprene-styrene block copolymer rubber, butadiene-styrene block copolymer rubber (SBR), butadiene-acrylonitrile block copolymer rubber, ethylene-propylene-(diene methylene) block copolymer rubber (EPDM), or isobutylene-isoprene block copolymer rubber (IIR) has at least 2 glass transition temperature Tg's since glass transition temperature Tg is observed with respect to each block segment. Of these, at least one glass transition temperature Tg is at most 20° C. and other glass transition temperature Tg's may be at most 20° C. or more than 20° C.

Of the above rubber-like polymers, conjugated diene-based rubber, urethane rubber, and silicone rubber are preferably used from the viewpoint of the appearance of a molded body. The conjugated diene-based rubber, specifically BR, SBR, EPDM, and BR are preferable since being easily cross-linked during kneading.

A rubber-like polymer may be one produced by any appropriate production method or one obtained as a commercially available product.

As commercially available products of conjugated diene-base rubber, for example, EPDM (NORDEL IP, produced by Dow Chemical Co.), ESPRENE (produced by Sumitomo Kagaku Co., Ltd.), and ROYALENE (produced by Uniroyal Chemical Co. Inc.) are usable.

As commercially available products of urethane rubber, for example, IRON RUBBER (produced by Unimatech Co., Ltd.) and E885 PFAA agipate-based rubber (produced by Japan Miractran Co.) are usable.

As commercially available products of silicone rubber, for example, one-component RTV rubber (produced by Shin-Etsu Chemical Co., Ltd.) and silicone varnish (produced by Shin-Etsu Chemical Co., Ltd.), and millable-type silicone rubber (produced by Momentive Performance Materials Inc.) are usable.

The blending amount of a (C) component is 5-30% by mass based on the total composition amount, but preferably 5-20% by mass, more preferably 5-15% by mass from the viewpoint of further enhancing flame-retardant performance and mechanical performance. When the blending amount of the (C) component is excessively small, mechanical characteristics, specifically impact strength is decreased. When the blending amount is excessively large, flame self-extinction performance is decreased and mechanical characteristics, specifically bending strength and elastic modulus are degraded.

[(D) Component]

As a polymer of a carbon residue rate of at least 15% used as a (D) component, a phenol resin, an epoxy resin, polyimide, a urea resin, a furan resin, unsaturated polyester, and polyphenylene sulfide (hereinafter referred to also as PPS) are usable. Herein, the phrase of “a carbon residue rate of at least 15%” refers to the rate of the residue amount at 600° C. in which a polymer is subjected to thermal mass analysis in nitrogen at a heating rate of 5° C./min. A preferable polymer includes a phenol resin and PPS of a carbon residue rate of at least 35%.

PPS is polyphenylene sulfide well-known as a so-called engineering plastic. Those having a softening point Tm of 240-300° C., preferably 240-290° C. are used. In the present specification, the softening point is a value determined using DSC7020 (produced by Seiko Instruments Inc.).

As PPS, those produced by a well-known method may be used, or those obtained as commercially available products may be used.

As commercially available products of PPS, for example, TORELINA (produced by Toray Industries, Inc.) and PPS (produced by DIC Corp.) are available.

A phenol resin is a polymer material obtained via addition/condensation of a phenol and an aldehyde.

Such a phenol includes, for example, phenol, cresol, xylenol, p-alkyphenol, p-phenylphenol, chlorophenol, bisphenol A, phenol sulfonic acid, and resorcin.

The aldehyde includes, for example, formalin and furfural.

As phenol resins, for example, a phenol-formalin resin, a cresol-formalin resin, a modified phenol resin, a phenol-furfural resin, and a resorcin resin are known, based on the raw materials.

As such a phenol-formalin resin, there are further listed, based on the production method, a novolac-type resin in which a precursor material is produced using an acidic catalyst and then curing reaction is carried out using an alkaline catalyst and a resol-type resin in which a precursor material is produced using an alkaline catalyst and then curing reaction is carried out using an acidic catalyst.

As a phenol resin, a phenol-formalin resin, specifically a novolac-type phenol-formalin resin is preferably used.

Using either of a powdery and a liquid phenol resin, the object of the present invention can be achieved. A preferable phenol resin is one which is powder at room temperature, since exhibiting excellent handling during weighing. Such a phenol resin preferably has a melting point of 35° C.-150° C., since being able to be used as a cross-linking agent of a rubber-like polymer, and the resin more preferably has a melting point of 60° C.-120° C.

As a phenol resin, those produced by a well-known method may be used, or those obtained as commercially available products may be used.

As commercially available products of such a phenol resin, for example, PR-HF-3 (produced by Sumitomo Bakelite Co., Ltd.) and phenol resin SP90 (produced by Asahi Organic Chemicals Ind. Co., Ltd.) are available.

From the viewpoint of flame self-extinction performance, at least a phenol resin is preferably used. Further, a phenol resin and PPS are more preferably used in combination.

The blending amount of a (D) component is 0.5-5% by mass based on the total composition amount. When the blending amount of the (D) component is specifically at least 1% by mass, a molded body produced using an obtained resin composition exhibits flame self-extinction performance. In the case of at least 2% by mass, burning rate is decreased and also ignition is hard to perform even when the flame of a match is allowed to approach. When the blending amount of the (D) component is excessively small, flame self-extinction performance is decreased. When the blending amount is excessively large, mechanical characteristics, specifically impact strength and bending strength are degraded. With respect to each of PPS and a phenol resin, a mixed material of at least 2 types of polymers differing in at least either of type and softening point-melting point is employable. PPS and a phenol resin may be used individually or in combination. In this case, the total blending amount of these resins needs only to fall within the above range.

[(E) Component]

As a (E) component, PEN is added at 1.0-10% by mass. The inherent viscosity of PEN is not specifically limited, being, however, preferably 0.30-2.50 dl/g, more preferably 0.60-1.5 dl/g in the present invention. When the inherent viscosity is excessively small, adequate impact resistance is not achieved and chemical resistance may be decreased. In contrast, when the inherent viscosity is excessively large, fluid viscosity is increased and thereby high kneading temperature needs to be set, resulting in kneading at an unfavorable temperature for other combined additives.

In the present specification, the inherent viscosity is a value determined using a phenol/tetrachloroethane (mass ratio: 1/1) mixed solvent at 30° C.

[Addition of Flame Retardant]

In the present invention, when a flame retardant containing no halogen is additionally added, flame-retardant performance is further enhanced. A preferable flame retardant in the present invention is a phosphoric acid ester compound.

As the phosphoric acid ester compound, esterified compounds of phosphorous acid, phosphoric acid, phosphonous acid, and phosphonic acid are used.

Specific examples of a phosphorous acid ester include, for example, triphenyl phosphite, tris(nonylphenyl)phosphite, tris(2,4-di-t-butylphenyl)phosphite, distearylpentaerythritol diphosphite, bis(2,6-di-t-butyl-4-methylphenyl)pentaerythritol diphosphite, and bis(2,4-di-t-butylphenyl)pentaerythritol diphosphite.

Specific examples of a phosphoric acid ester include, for example, triphenyl phosphate (TPP), tris(nonylphenyl)phosphate, tris(2,4-di-t-butylphenyl)phosphate, distearylpentaerythritol diphosphate, bis(2,6-di-t-butyl-4-methylphenyl)pentaerythritol diphosphate, bis(2,4-di-t-butylphenyl)pentaerythritol diphosphate, tributyl phosphate, and bisphenol-A bis(diphenyl phosphate).

Specific examples of a phosphonous acid ester include, for example, tetrakis(2,4-di-t-butylphenyl)-4,4′-biphenylenephosphonite.

Specific examples of a phosphonic acid include, for example, dimethyl benzenephosphonate and benzene phosphonate.

As the phosphoric acid ester compound, esterified compounds of phosphorous acid, phosphoric acid, and phosphoric acid are preferable, and a phosphoric acid ester is specifically preferable.

As preferable combinations of the (A)-(E) components, the following combinations are listed.

<1> (A) PET-(B) PC-(C) EPDM-(D) phenol resin-(E) PEN

<2> (A) PET-(B) PC-(C) EPDM-(D) phenol resin and PPS-(E) PEN

[Other Additives]

The resin composition of the present invention can be blended, within the scope where the object of the present invention is achieved, with other commonly used additives including, for example, a cross-linking agent, a pigment, a dye, a reinforcing agent (such as glass fiber, carbon fiber, talc, mica, a clay mineral, or potassium titanate fiber), a filler (such as titanium oxide, metal powder, wood powder, or chaff), a thermal stabilizer, an antioxidant, a UV absorbent, a lubricant, a releasing agent, a crystal nucleus agent, a plasticizer, a flame retardant, an antistatic agent, and a foaming agent. Of these, also from the viewpoint of inhibiting transesterification reaction of a polyester resin and a polycarbonate resin and thermal decomposition, in the resin composition of the present invention, a cross-linking agent and a stabilizer such as a thermal stabilizer or an antioxidant are suitably added.

A cross-linking agent accelerates cross-linking of a rubber-like polymer (C). For example, a peroxide is preferably used. Specific examples of such a peroxide include, for example, acetylcyclohexyl sulfonyl peroxide, isobutyl peroxide, diisopropyl peroxydicarbonate, di-n-propyl peroxydicarbonate, di-(2-methoxyethyl)peroxydicarbonate, di-(methoxyisopropyl)peroxydicarbonate, di(2-methylhexyl)peroxydicarbonate, t-butyl peroxyneodecanoate, 2,4-dichlorobonzoyl peroxide, t-butyl peroxypivalate, 3,5,5-trimethylhexanol peroxide, octanol peroxide, decanol peroxide, lauroyl peroxide, stearoyl peroxide, propionyl peroxide, acetyl peroxide, t-butyl peroxy(2-ethylhexanoate), benzoxy peroxide, t-butyl peroxyisobutyrate, 1,1-bis(t-butylperoxy)-3,3,5-trimethylcyclohexanone, 1,1-bis(t-butylperoxy)cyclohexanone, t-butyl peroxymaleic acid, succinic acid peroxide, t-butyl peroxylaurate, t-butylperoxy 3,5,5-trimethylhexanoate, cyclohexanone peroxide, t-butyl-peroxyisopropylcarbonate, 2,5-dimethyl-2,5-di(benzoylperoxy)hexane, t-butyl peroxyacetate, 2,2-bis(t-butylperoxy)butane, t-butylperoxy benzoate, di-t-butyl diperoxyphthalate, n-butyl-4,4-bis(t-butylperoxy)valerate, methyl ethyl ketone peroxide, dicumyl peroxide, 2,5-dimethyl-2,5-di(t-butylperoxy)hexane, t-butylcumyl peroxide, t-butyl hydroperoxide, di-isopropylbenzene hydroperoxide, di-t-butyl peroxide, p-methane hydroperoxide, 2,2-dimethyl-2,5-di(t-butylperoxy) hexine-3,1,1,3,3-tetramethylbutyl hydroperoxide, 2,5-dimethylhexane-2,5-dihydroxyperoxide, and cumene hydroperoxide.

The blending amount of a cross-linking agent is preferably 0.01-0.1% by mass, more preferably 0.01-0.05% by mass, based on the total resin composition amount.

As a thermal stabilizer, a phosphor-based, hindered phenol-based, amine-based, or thioether-based compound is usable. Of these, a thioether-based compound is preferable. Such a thioether-based compound includes dilauryl thiodipropionate, dimyristyl thiodipropionate, distearyl thiodipropionate, lauryl stearyl thiodipropionate, and tetrakis[methylene-3-(dodecylthio)propionate]methane.

The blending amount of a thermal stabilizer is preferably 0.001-1% by mass, more preferably 0.01-0.5% by mass, based on the total resin composition amount.

[Production Method of Flame-Retardant Polyester Resin Composition]

A resin composition according to the present invention can be produced by a so-called melt-kneading method. Namely, a polymer mixture containing at least the above (A)-(E) components is melted/kneaded and then cooled. The thus-cooled material is commonly pelletized via pulverization in order to make the processing of the following step (for example, a molding step) easy.

The melting/kneading method is not specifically limited. For example, a well-known extrusion kneader employing shearing force can be used. Specifically, an extrusion kneader, which is employable in a preferred embodiment to be described later, is usable.

Melting/kneading conditions are not specifically limited. For example, the number of screw rotations and processing temperature fall within the ranges employable in the preferred embodiment to be described later.

The cooling method is not specifically limited. Either cooling in air or rapid cooling to be described later may be carried out.

(Production Method According to the Preferred Embodiment)

When the resin composition of the present invention is produced by the following production method according to the preferred embodiment, fine dispersion of a rubber-like polymer (C) is realized. In addition, flame self-extinction performance and mechanical performance such as elastic modulus, bending strength, and impact strength are enhanced.

A preferable production method of the resin composition of the present invention has a feature in which a polymer mixture containing at least the above (A)-(E) components is subjected to gap passing treatment in the melt state.

The gap passing treatment refers to treatment in which a polymer mixture of the melt state is passed through the gap of 2 parallel flat planes having an interplanar distance x of at most 5 mm. In the present embodiment, the gap passing treatment is carried out more than once, preferably more than twice, still more preferably more than 3 times. Thereby, each component contained in such a polymer mixture is sufficiently uniformly mixed/dispersed, whereby even with no inclusion of a flame retardant containing a halogen atom, there is obtained a resin composition exhibiting more excellent flame-retardant performance, specifically flame self-extinction performance, as well as even exhibiting remarkably enhanced mechanical performance such as elastic modulus, bending strength, and impact strength. Such effects are produced also in a molded body obtained using the resin composition. As the number of times of the gap passing treatment is increased, flame self-extinction performance and mechanical performance are remarkably enhanced. For example, when the number of times of the gap passing treatment is increased from once to twice, flame self-extinction performance and mechanical performance are more remarkably enhanced. When the number of times of the gap passing treatment is increased from twice to 3 times, flame self-extinction performance and mechanical performance are still more remarkably enhanced. The upper limit of the number of times of the gap passing treatment is commonly 1000 times, specifically 100 times. Even when a polymer mixture is passed through the gap of an interplanar distance x of less than 5 mm, flame-retardant performance and mechanical performance such as elastic modulus, bending strength, and impact strength are not surely enhanced remarkably. Even when the moving direction distance of the polymer mixture in such a gap is extended, flame-retardant performance and mechanical performance are not surely enhanced remarkably. When the gap passing treatment is carried out after kneading using a uniaxial or biaxial kneader, the number of times of this treatment can be decreased. For example, when the gap passing treatment is carried out using an apparatus placed at the ejection opening of a biaxial kneader, the number of times thereof can be decreased to 3-10.

The detail of the mechanism in which effects of remarkably enhancing flame-retardant performance and mechanical performance are produced is unclear but thought to be based on the following mechanism. When a polymer mixture of the melt state enters the gap, the pressure applied to the polymer mixture and the moving velocity thereof varys to a large extent. It is conceivable that, at this moment, shearing action, elongation action, and folding action efficiently work on the melted material. Thereby, it is thought that the polymer mixture is affected by such changes, whereby sufficient and uniform mixing/dispersion of each component is efficiently achieved, and thereby remarkably enhanced effects of the flame-retardant performance and mechanical performance are realized.

When carried out at least twice, gap passing treatment may be achieved using an apparatus having at least 2 gaps by passing through each gap once, or using an apparatus having only one gap by passing through the gap at least twice. From the viewpoint of the efficiency of continuous operation, such gap passing treatment is preferably achieved using an apparatus having at least 2 gaps by passing through each gap once.

In at least one gap, the interplanar distance x of 2 parallel flat planes each is independently at most 5 mm, specifically 0.05-5 mm, being, however, preferably 0.5-5 mm, more preferably 0.5-3 mm from the viewpoint of more uniform mixing/dispersion, apparatus size reduction, and venting-up prevention.

The distance y of the moving direction MD of a polymer mixture in at least one gap each needs only to be independently at least 2 mm, being, however, preferably at least 3 mm, more preferably at least 5 mm, still more preferably 10 mm from the viewpoint of further enhancement of treatment effects. The upper limit of the distance y is not specifically limited. However, an excessively large distance thereof produces decreased efficiency and in addition, the pressure to move a polymer mixture in the moving direction MD needs to be increased, resulting in being uneconomical. Therefore, each distance y is independently preferably 2-100 mm, more preferably 3-50 mm, still more preferably 5-30 mm.

In at least one gap, the distance z of the width direction WD is not specifically limited, being, for example, at least 20 mm and commonly 100-1,000 mm.

The flow rate when a polymer mixture is passed through the gap in the melt state needs only to be at least 1 g/minute based on the value per cross-sectional area cm² of the gap. In the present embodiment, the upper limit is not specifically limited. However, when the cross-sectional area is excessively large, the pressure to move the polymer mixture in the moving direction MD needs to be increased, resulting in being uneconomical. The flow rate is preferably 10-5,000 g/minute, more preferably 10-500 g/minute.

In the present specification, the cross-sectional area refers to an area in the vertical cross-section with respect to the moving direction MD.

The flow rate can be determined by dividing the ejection amount (g/minute) of a polymer mixture ejected from an ejection opening by the cross-sectional area (cm²) of a gap.

The viscosity of a polymer mixture during gap passing treatment is not specifically limited as long as the flow rate during the gap passing is achieved, being controllable by heating temperature. The viscosity is, for example, 1-10,000 Pa·s, preferably 10-8,000 Pa·s.

As the viscosity of a polymer mixture, a value determined using viscoelasticity measuring instrument MARS (produced by Haake) is employed.

The pressure to move a polymer mixture of the melt state in the moving direction MD is not specifically limited as long as the flow rate during the gap passing is achieved, being preferably at least 0.1 MPa in terms of the resin pressure shown by the differential pressure from atmospheric pressure. The resin pressure refers to the pressure of a polymer mixture measured at an interior point distant from the ejection opening of the resin in the gap by at least 1 mm, being able to be determined via direct measurement using a pressure meter. Higher pressure is more effective. However, when the resin pressure is excessively large, shearing heat is markedly generated, whereby a polymer may be decomposed. Therefore, the resin pressure is preferably at most 500 Mpa, more preferably at most 50 Mpa. With regard to this resin pressure, a guideline to produce a polymer composition exhibiting excellent physical properties has been just shown. Therefore, if the object of the present embodiment is achieved employing any resin pressure other than the above one, such a resin pressure is not limited.

The temperature of a polymer mixture during gap passing treatment is not specifically limited provided that the flow rate during the gap passing treatment is achieved. Since high temperatures of more than 400° C. cause polymer decomposition, a temperature of at most 400° C. is recommended. Further, the polymer mixture temperature is preferably a temperature of at least the glass transition temperature Tg of a polymer, since the resin pressure is not extremely increased. When at least 2 types of polymers are used, a value calculated from the ratio thereof and each glass transition temperature Tg by weighted average is designated as glass transition temperature Tg. For example, when the glass transition temperature Tg of a polymer A is Tg_{A} (° C.) and the used ratio is R_{A} (%); and the glass transition temperature Tg of a polymer B is Tg_{B} (° C.) and the used ratio is R_{B} (%), the following relationships are satisfied: (R_{A}+R_{B}=100) and glass transition temperature Tg=[(Tg_{A}×R_{A}/100)+(Tg_{B}×R_{B}/100)].

The polymer mixture temperature during gap passing treatment can be controlled by adjusting the heating temperature of an apparatus to carry out this treatment.

In the present embodiment, commonly, immediate prior to gap passing treatment, a polymer mixture is melted/kneaded using an extrusion kneader and after kneading, the polymer mixture of the melted state having been extruded is subjected to gap passing treatment at a predetermined number of times. The melting/kneading method is not specifically limited. For example, a well-known extrusion kneader employing shearing force is usable. Specifically, for example, an extrusion kneader such as biaxial extrusion kneaders KTX30 and KTX46 (produced by Kobe Steel, Ltd.) can be used.

Melting/kneading conditions are not specifically limited. For example, a screw rotational number of 50-1,000 rpm is employable. With regard to melting/kneading temperature, the same temperature as the temperature of a polymer mixture during the above gap passing treatment is employable.

With reference to the drawings of production apparatuses of a polymer composition to carry out gap passing treatment, gap passing treatment methods will now be specifically described. Such production apparatuses of a polymer composition incorporate an inflow opening to allow a material, to be treated, to flow inward and an ejection opening to eject a treated material, having further a gap containing 2 parallel flat planes at a location or more in the flow path of the material to be treated between the inflow opening and the ejection opening.

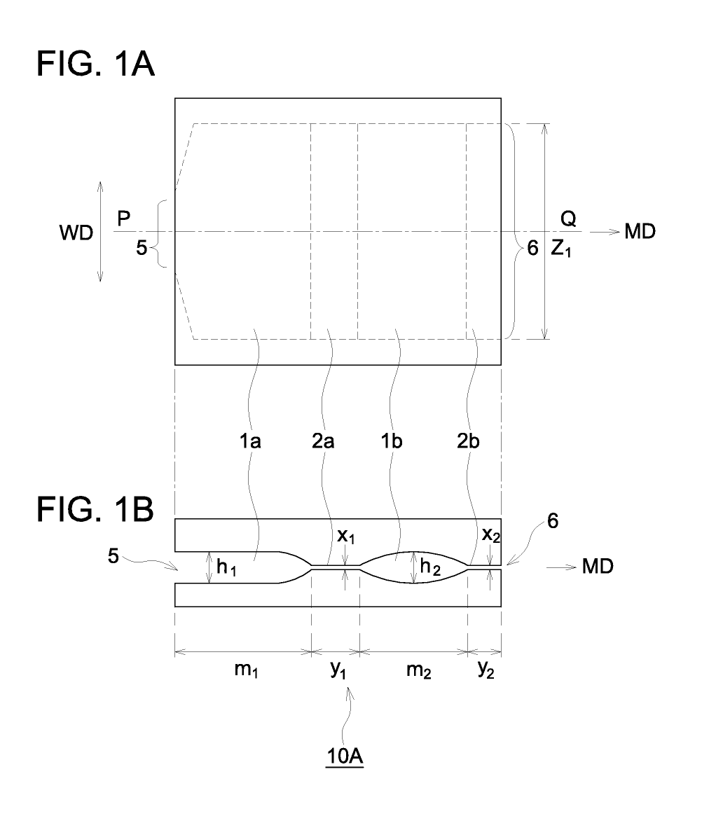

For example, a production apparatus (die) of a polymer composition in which gap passing treatment is carried out once is the same as the apparatus shown in FIG. 1 to be described later except that no gap 2a is provided and an accumulation section 1a and an accumulation section 1b are communicatively connected together at the same height as the maximum height of these accumulation sections. Therefore, the description of the apparatus will be omitted.

For example, one example of a production apparatus (die) of a polymer composition in which gap passing treatment is carried out twice is shown in FIG. 1. Herein, FIG. 1A is a schematic perspective view of the production apparatus of a polymer composition in which gap passing treatment is carried out twice when the interior of the apparatus is seen through from the top, and FIG. 1B is a schematic cross-sectional view at the P-Q cross-section of the apparatus of FIG. 1A. The apparatus of FIG. 1 has an almost rectangular shape as a whole. In the apparatus of FIG. 1, the inflow opening 5 is allowed to be connected to the ejection opening of an extrusion kneader (not shown), whereby the extrusion force of the extrusion kneader is utilized as the driving force of movement of a polymer mixture. Thereby, the polymer mixture of the melted state can be entirely moved in the moving direction MD and then passed through the gaps 2a and 2b. In this manner, since being used by being connected to the ejection opening of the extrusion kneader, the apparatus of FIG. 1 can be also referred to as a die.

The apparatus of FIG. 1 is specifically provided with the inflow opening 5 to allow a material, to be treated, to flow inward and the ejection opening 6 to eject a treated material, further having gaps containing 2 parallel flat planes at 2 locations (2a and 2b). Commonly, immediately before each of the gaps 2a and 2b, accumulation sections 1a and 1b which are larger in cross-sectional area than the gaps are further provided. During treatment, a polymer mixture having been extruded from an extrusion kneader flows into the accumulation section 1a from the inflow opening 5 in the apparatus 10A of FIG. 1 in the melted state based on the extrusion force of the extrusion kneader and then spreads in the width direction WD. Subsequently, the polymer mixture continuously passes through the gap 2a in the moving direction MD and in the width direction WD and then moves to the accumulation section 1b, followed by passing through the gap 2b to be ejected from the ejection opening 6.

In the present specification, the cross-sectional area of an accumulation section refers to the maximum cross-sectional area of the accumulation section in the vertical cross-section with respect to the moving direction MD.

In FIG. 1, the interplanar distances x₁ and x₂ between 2 parallel flat planes each in the gaps 2a and 2b are equivalent to the above distance x, each of which independently needs only to fall within the same range as in the distance x.

In FIG. 1, the distance y₁ of the moving direction MD in the gap 2a and the distance y₂ of the moving direction MD in the gap 2b are equivalent to the distance y, each of which independently needs only to fall within the same range in the distance y.

In FIG. 1, the distances z₁ of the width direction WD in the gaps 2a and 2b are equivalent to the above distance z, which independently need only to fall within the same range in the distance z, being commonly a common value.

In FIG. 1, the maximum heights h₁ and h₂ in the accumulation sections 1a and 1b each have larger values than the interplanar distances x₁ and x₂ of the gaps 2a and 2b immediate thereafter, being each independently commonly 3-100 mm, preferably 3-50 mm.

In the present specification, the maximum height of an accumulation section refers to the maximum height in the vertical cross-section with respect to the width direction WD in a rectangular apparatus.

In FIG. 1, the ratio S₁ₐ/S₂ₐ of the maximum cross-sectional area S₁ₐ of the accumulation section 1a to the cross-sectional area S₂ₐ of the gap 2a immediately thereafter and the ratio S_{1b}/S_{2b} of the maximum cross-sectional area S_{1b} of the accumulation section 1b to the cross-sectional area S_{2b} of the gap 2b immediately thereafter are each independently at least 1.1, specifically 1.1-1000, being preferably 2-100, more preferably 3-15 from the viewpoint of more uniform mixing/dispersion, apparatus size reduction, and venting-up prevention.

In FIG. 1, the distance m₁ of the moving direction MD in the accumulation section 1a and the distance m₂ of the moving direction MD in the accumulation section 1b each independently need only to be at least 1 mm. However, the distances are preferably at least 2 mm, more preferably at least 5 mm, still more preferably at least 10 mm from the viewpoint of continuous operation efficiency. The upper limits of the distances m₁ and m₂ are not specifically limited. However, in the case of excessively large distance, poor efficiency results and in addition, the extrusion force of an extrusion kneader connected to the inflow opening 5 needs to be increased, resulting in being uneconomical. Therefore, the distances m₁ and m₂ are each independently 1-300 mm.

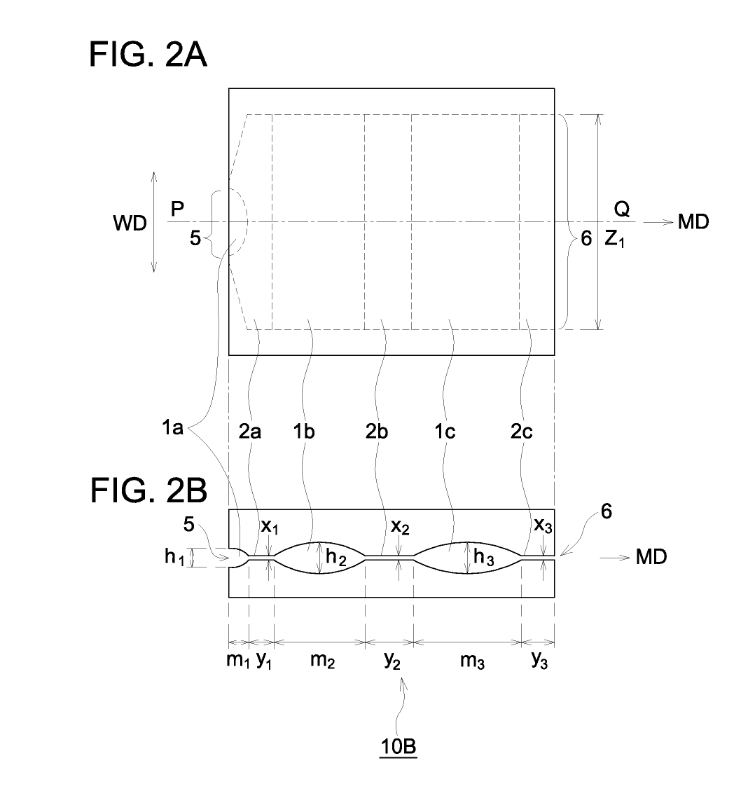

Further, for example, one example of a production apparatus (die) of a polymer composition in which gap passing treatment is carried out 3 times is shown in FIG. 2. Herein, FIG. 2A is a schematic perspective view of the production apparatus of a polymer composition in which gap passing treatment is carried out 3 times when the interior of the apparatus is seen through from the top, and FIG. 2B is a schematic cross-sectional view at the P-Q cross-section of the apparatus of FIG. 2A. The apparatus of FIG. 2 has an almost rectangular shape as a whole. In the apparatus of FIG. 2, the inflow opening 5 is allowed to be connected to the ejection opening of an extrusion kneader (not shown), whereby the extrusion force of the extrusion kneader is utilized as the driving force of movement of a polymer mixture. Thereby, the polymer mixture of the melted state can be entirely moved in the moving direction MD and then passed through the gaps 2a, 2b, and 2c. In this manner, since being also used by being connected to the ejection opening of the extrusion kneader, the apparatus of FIG. 2 can be referred to as a die.

The apparatus of FIG. 2 is specifically provided with the inflow opening 5 to allow a material, to be treated, to flow inward and the ejection opening 6 to eject a treated material, further having gaps containing 2 parallel flat planes at 3 locations (2a, 2b, and 2c) in the flow path of the material to be treated between the inflow opening 5 and the ejection opening 6. Commonly, immediately before each of the gaps 2a, 2b, and 2c, accumulation sections 1a, 1b, and 1c which are larger in cross-sectional area than the gaps immediately thereafter are further provided. During treatment, a polymer mixture having been extruded from an extrusion kneader flows into the accumulation section 1a from the inflow opening 5 in the apparatus 10B of FIG. 2 in the melted state based on the extrusion force of the extrusion kneader and then spreads in the width direction WD. Subsequently, the polymer mixture continuously passes through the gap 2a in the moving direction MD and in the width direction WD and then moves to the accumulation section 1b. Then, the polymer mixture passes through the gap 2b and moves to the accumulation section 1c, followed by finally passing through the gap 2c to be ejected from the ejection opening 6.

In FIG. 2, the interplanar distances x₁, x₂, and x₃ between 2 parallel flat planes each in the gaps 2a, 2b, and 2c are equivalent to the above distance x, each of which independently needs only to fall within the same range as in the distance x.

In FIG. 2, the distance y₁ of the moving direction MD in the gap 2a, the distance y₂ of the moving direction MD in the gap 2b, and the distance y₃ of the moving direction MD in the gap 2c are equivalent to the distance y, each of which independently needs only to fall within the same range in the distance y.

In FIG. 2, the distances z₁ of the width direction WD in the gaps 2a, 2b, and 2c are equivalent to the above distance z, which independently need only to fall within the same range in the distance z, being commonly a common value.

In FIG. 2, the maximum heights h₁, h₂, and h₃ in the accumulation sections 1a, 1b, and 1c each have larger values than the interplanar distances x₁, x₂, and x₃ of the gaps 2a, 2b, and 2c immediate thereafter, each commonly independently falling within the same range as in the maximum heights h₁ and h₂ in FIG. 1.

In FIG. 2, the ratio S₁ₐ/S₂ₐ of the maximum cross-sectional area S₁ₐ of the accumulation section 1a to the cross-sectional area S₂ₐ of the gap 2a immediately thereafter, the ratio S_{1b}/S_{2b} of the maximum cross-sectional area S_{1b} of the accumulation section 1b to the cross-sectional area S_{2b} of the gap 2b immediately thereafter, and the ratio S_{1c}/S_{2c} of the maximum cross-sectional area S_{1c} of the accumulation section 1c to the cross-sectional area S_{2c} of the gap 2c immediately thereafter each independently fall within the same range as in the ratio S₁ₐ/S₂ₐ and the ratio S_{1b}/S_{2b}.

In FIG. 2, the distance m₁ of the moving direction MD in the accumulation section 1a, the distance m₂ of the moving direction MD in the accumulation section 1b, and the distance m₃ of the moving direction MD in the accumulation section 1c each independently fall within the same range as in the distance m₁ and the distance m₂ in FIG. 1.

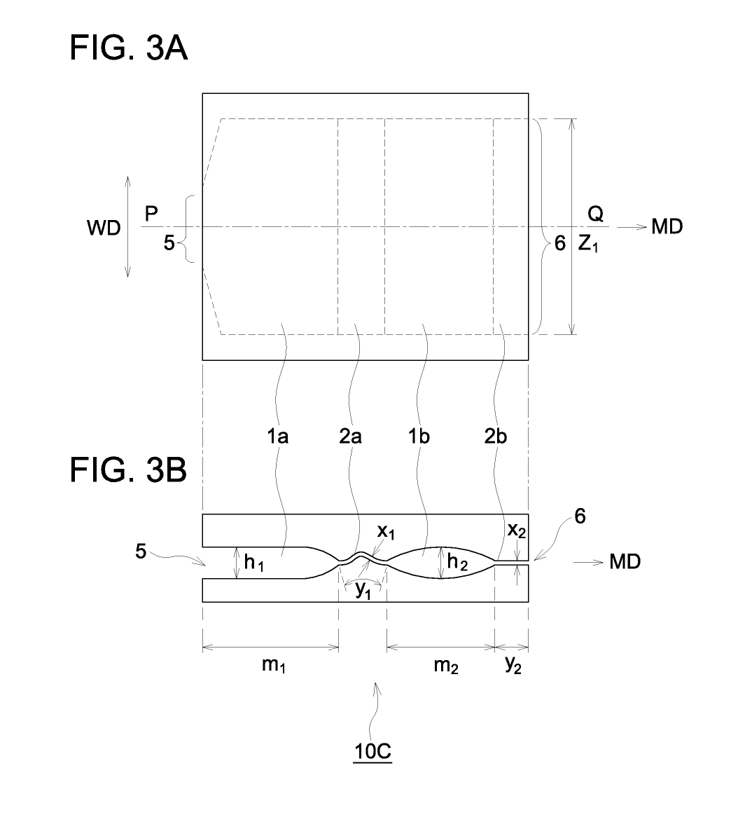

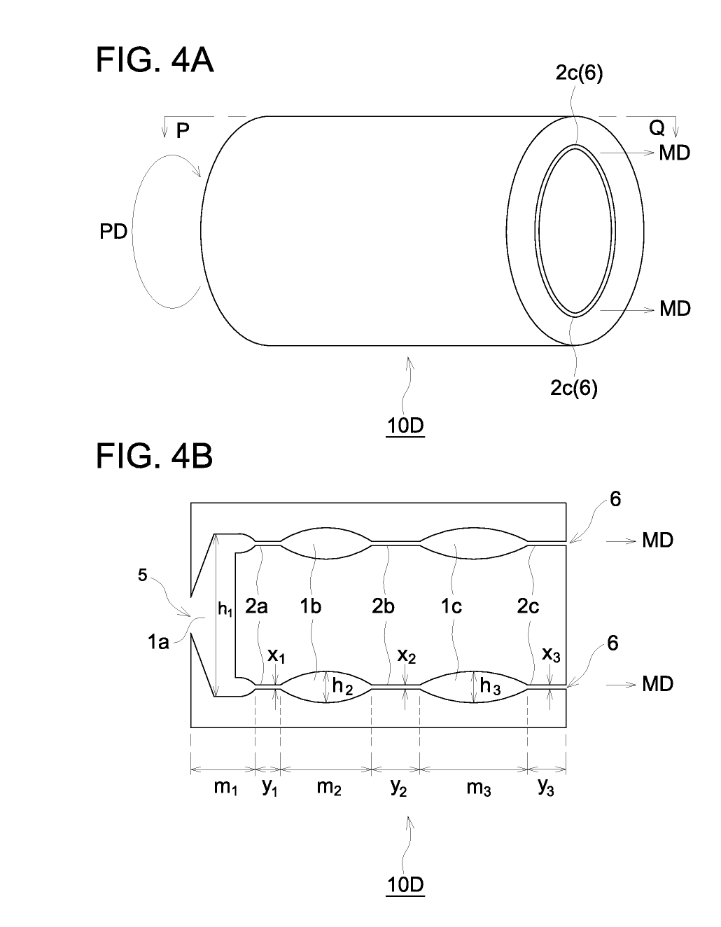

In the present specification, the term “parallel” is used in a concept in which the parallel relationship achieved not only between 2 flat planes but also between 2 curved planes is included. Namely, in FIG. 1 and FIG. 2, the gaps 2a, 2b, and 2c each contain 2 parallel flat planes, which are not limited. For example, as in the gap 2a shown in FIG. 3 and the gaps 2a, 2b, and 2c shown in FIG. 4, a constitution in which 2 parallel curved planes are employed may be made. The term “parallel” means that in the 2 plane relationship, the distance between these planes is constant and needs not to be strictly “constant” but needs only to be practically “constant” in view of the accuracy during apparatus production. Therefore, “parallel” may be “almost parallel” within the scope where the object of the present embodiment is achieved. In an almost rectangular apparatus, the shape and location of a gap in the vertical cross-section with respect to the width direction WD will not vary in the width direction. In such an almost rectangular apparatus, the shape and location of a gap in a cross-section passing through the axis will not vary in the peripheral direction in which the axis of the apparatus is designated as the center line.

FIG. 3 shows one example of a production apparatus (die) of a polymer composition in which gap passing treatment is carried out twice. Herein, FIG. 3A is a schematic perspective view of the production apparatus of a polymer composition in which gap passing treatment is carried out twice when the interior of the apparatus is seen through from the top, and FIG. 3B is a schematic cross-sectional view at the P-Q cross-section of the apparatus of FIG. 3A. The apparatus of FIG. 3 has an almost rectangular shape as a whole. In the apparatus of FIG. 3, the inflow opening 5 is allowed to be connected to the ejection opening of an extrusion kneader (not shown), whereby the extrusion force of the extrusion kneader is utilized as the driving force of movement of a polymer mixture. Thereby, the polymer mixture of the melted state can be entirely moved in the moving direction MD and then passed through the gaps 2a and 2b. In this manner, since being also used by being connected to the ejection opening of the extrusion kneader, the apparatus of FIG. 3 can be referred to as a die.

The apparatus of FIG. 3 is the same as the apparatus of FIG. 1 except that the gap 2a contains 2 parallel curved planes. Therefore, the detailed description of the apparatus of FIG. 3 will be omitted.

FIG. 4 shows one example of a production apparatus (die) of a polymer composition in which gap passing treatment is carried out 3 times. Herein, FIG. 4A is a schematic sketch of the production apparatus of a polymer composition in which gap passing treatment is carried out 3 times, and FIG. 4B is a schematic cross-sectional view at the P-Q cross-section passing through the axis of the apparatus of FIG. 4A. The apparatus of FIG. 4 has an almost circular shape as a whole which enables to realize the size reduction of the apparatus. In the apparatus of FIG. 4, the inflow opening 5 is allowed to be connected to the ejection opening of an extrusion kneader (not shown), whereby the extrusion force of the extrusion kneader is utilized as the driving force of movement of a polymer mixture. Thereby, the polymer mixture of the melted state can be entirely moved in the moving direction MD and then passed through the gaps 2a, 2b, and 2c. In this manner, since being also used by being connected to the ejection opening of the extrusion kneader, the apparatus of FIG. 4 can be referred to as a die.

The apparatus of FIG. 4 is specifically provided with the inflow opening 5 to allow a material, to be treated, to flow inward and the ejection opening 6 to eject a treated material, further having gaps containing 2 parallel curved planes at 3 locations (2a, 2b, and 2c). Commonly, immediately before each of the gaps 2a, 2b, and 2c, accumulation sections 1a, 1b, and 1c which are larger in cross-sectional area than the gaps immediately thereafter are further provided. During treatment, a polymer mixture having been extruded from an extrusion kneader flows into the accumulation section 1a from the inflow opening 5 in the apparatus 10D of FIG. 4 in the melted state based on the extrusion force of the extrusion kneader and then spreads in the radius direction. Subsequently, the polymer mixture continuously passes through the gap 2a in the moving direction MD and in the peripheral direction PD and then moves to the accumulation section 1b. Then, the polymer mixture passes through the gap 2b and moves to the accumulation section 1c, followed by finally passing through the gap 2c to be ejected from the ejection opening 6.

In FIG. 4, the interplanar distances x₁, x₂, and x₃ between 2 parallel flat planes each in the gaps 2a, 2b, and 2c are equivalent to the above distance x, each of which independently needs only to fall within the same range as in the distance x.

In FIG. 4, the distance y₁ of the moving direction MD in the gap 2a, the distance y₂ of the moving direction MD in the gap 2b, and the distance y₃ of the moving direction MD in the gap 2c are equivalent to the distance y, each of which independently needs only to fall within the same range in the distance y.

In FIG. 4, the maximum height h₁ in the accumulation section 1a is not specifically limited, being commonly 1-100 mm, preferably 1-50 mm.

In FIG. 4, the maximum heights h₂ and h₃ in the accumulation sections 1b and 1c each have larger values than the interplanar distances x₂ and x₃ of the gaps 2b and 2c immediate thereafter, each commonly independently falling within the same range as in the maximum heights h₁ and h₂ in FIG. 1.

In the present specification, the maximum height of an accumulation section refers to the maximum height of the diameter direction in the cross-section passing through the axis of the apparatus in an almost circular apparatus.

In FIG. 4, the ratio S₁ₐ/S₂ₐ of the maximum cross-sectional area S₁ₐ of the accumulation section 1a to the cross-sectional area S₂ₐ of the gap 2a immediately thereafter is at least 1.2, specifically 1.2-10, being, however, preferably 1.2-7, more preferably 1.2-5 from the viewpoint of more uniform mixing/dispersion, apparatus size reduction, and venting-up prevention.

In FIG. 4, the ratio S_{1b}/S_{2b} of the maximum cross-sectional area S_{1b} of the accumulation section 1b to the cross-sectional area S_{2b} of the gap 2b immediately thereafter and the ratio S_{1c}/S_{2c} of the maximum cross-sectional area S_{1c} of the accumulation section 1c to the cross-sectional area S_{2c} of the gap 2c immediately thereafter each independently fall within the same range as in the ratio S₁ₐ/S₂ₐ and the ratio S_{1b}/S_{2b}.

In FIG. 4, the distance m₁ of the moving direction MD in the accumulation section 1a, the distance m₂ of the moving direction MD in the accumulation section 1b, and the distance m₃ of the moving direction MD in the accumulation section 1c each independently fall within the same range as in the distance m₁ and the distance m₂ in FIG. 1.

The apparatuses described in FIG. 1-FIG. 4 are commonly produced using materials employed in production of dice conventionally used by being attached to the ejection opening in the field of resin kneaders and extruders.

After gap passing treatment, a polymer mixture having been subjected to the gap passing treatment is rapidly cooled.

Rapid cooling can be realized in such a manner that a polymer composition of the melted state obtained by gap passing treatment is immersed in water of 0-60° as such. Further, rapid cooling may be realized via cooling with a gas of −40° C.-60° C. or via contact with a metal of −40° C.-60° C. Such rapid cooling needs not always to be carried out. For example, even via cooling in air, a sufficiently uniformly mixed/dispersed form of various kinds of components can be maintained.

The thus-cooled polymer composition is commonly pelletized via pulverization to make the following step easy.

In the present embodiment, prior to melting/kneading treatment carried out immediately prior to gap passing treatment of a polymer mixture, all the components constituting the polymer mixture may be previously mixed. For example, all the components are previously mixed and then subjected to melting/kneading treatment immediately prior to gap passing treatment, followed by gap passing treatment of a predetermined number of times. After such mixing, it is preferable that immediately prior to melting/kneading treatment, the polymer mixture is sufficiently dried from the viewpoint of preventing the hydrolysis reaction of a polyester resin and the transesterification reaction of a polyester resin and a polycarbonate resin.

As the mixing method, a dry blending method in which a predetermined component is simply dry-mixed may be employed or a melting/kneading method in which a predetermined component is melted/kneaded, cooled, and pulverized by a conventional melting/kneading method may be employed. When the melting/kneading method is employed, the same extrusion kneader as described above is usable. In this case, the extrusion kneader may be used in which a conventionally known die is attached to the ejection opening.

In a resin composition produced by the above gap passing treatment, a rubber-like polymer (C) is in the dispersed state at an average particle diameter of 1 nm-20 μm. From the viewpoint of impact strength and elastic modulus, the dispersion particle diameter is preferably 1 nm-15 μm, more preferably 10 nm-10 μm. Such a dispersion particle diameter is maintained also in a molded body obtained using the above resin composition.

In a resin composition produced without the above gap passing treatment, namely, in a resin composition of the present invention produced by a simple melting/kneading method, a rubber-like polymer (C) is commonly dispersed at an average particle diameter of 0.1-5 μm. Even in a resin composition in which a rubber-like polymer (C) is dispersed at such an average particle diameter, the effects of the present invention can be produced, provided that the above (A)-(D) compositions are contained.

[Applications of Flame-Retardant Polyester Resin Composition]

The resin composition of the present invention produced by the above method commonly has a pellet form via cooling/pulverization. Therefore, the pellet is applied to any of the well-known molding methods such as an injection molding method, an extrusion molding method, a compression molding method, a blow molding method, or an injection compression molding method, whereby a molded body provided with any appropriate shape can be produced. From the viewpoint of preventing the hydrolysis reaction of a polyester resin and the transesterification reaction of a polyester resin and a polycarbonate resin, prior to molding, a resin composition is preferably dried sufficiently.

As another method, without cooling/pulverization of the resin composition of the present invention in the melted state having been subjected to gap passing treatment, a molded body provided with any appropriate shape can be produced by being continuously applied to various well-known molding methods as described above.

The flame-retardant polyester resin composition of the present invention is useful as molding materials or constituent materials in which excellent flame-retardant performance, specifically flame self-extinction performance and excellent mechanical performance such as elastic modulus, bending strength, and impact strength are expressed. As such applications, for example, there are listed containers, wrapping film, household groceries, office equipment, audio-visual equipment, electric/electronic components, and automobile components.

### EXAMPLES

The present invention will now be described with reference to examples and comparative examples. However, it goes without saying that the scope of the present invention is not limited by the following examples unless the gist of the present invention is exceeded.

Initially, raw materials and a kneader used in the following examples and comparative examples will be described.

(A) Component

PET: A polyethylene terephthalate resin pellet of an inherent viscosity of 0.78 dl/g, having a melting point of 267° C. and a glass transition temperature of 73° C. based on the same DSC method as described above.

R-PET (recycled polyethylene terephthalate): A flake-shaped pulverized article (washed article) of a size of 2-8 mm of used and discarded PET bottles featuring an inherent viscosity of 0.68 dl/g. Herein, the terminal point temperature (melting point) of the crystal melting peak of this PET flake at a rising temperature rate of 20° C./minute was 263° C., based on a DSC method (DSC7000 produced by Seiko Instruments Inc. was used) and the glass transition temperature was 69° C. based on the same DSC method.

(B) Component

PC1 (recycled polycarbonate): Those having a size of 1-5 mm obtained by removing the reflective layer and the recording layer from discarded compact disks, followed by pulverization into a flake shape (PC for the substrate: IUPILON H4000 of a molecular weight of about 15,000, produced by Mitsubishi Engineering-Plastics Corp.). The glass transition point was 148° C. based on the same DSC method as described above.

PC2: TARFLON A2500 (molecular weight: about 23,000, produced by Idemitsu Petrochemical Co., Ltd.). The glass transition temperature was 168° C. based on the same DSC method as described above.

(C) Component

PAAV: Polyvinyl acetate (Tg: 30° C.)

COM1: A 1:1:3 mixture of polyethylene (HARMOREX of a Tg of −125° C., produced by Japan Polyethylene Corp.), an ethylene-acrylic acid copolymer (REXPERL EMA ET440H of a Tg of −120° C., produced by Japan Polyethylene Corp.), and EPDM

COM2: A 1:4 mixture of an ethylene-methyl acrylate copolymer (REXPERL EMA EB330H of a Tg of −120° C., produced by Japan Polyethylene Corp.) and EPDM

COM3: A 4:1 mixture of butadiene-styrene copolymer rubber (JSR DRY SBR, produced by JSR Corp.) having a diene content, a number average molecular weight, and a Tg of 26% by mass, 5×10⁵, and −35° C., respectively and polypropylene (BIREN of a Tg of 0° C., produced by Toyobo Co., Ltd.)

COM4: A 1:5 mixture of a copolymer of glycidyl methacrylate, polyethylene, and polystyrene copolymer (MODIPER A4100, produced by NOF Corp.) and EPDM

EPDM: Ethylene-propylene-diene copolymer rubber (EPDM, NORDEL IP, produced by Dow Chemicals Co.) having a diene content, a number average molecular weight, and a Tg of 17% by mass, 10⁵, and −37° C., respectively

St: Polystyrene (Tg: 86° C., produced by Mitsubishi Chemical Corp.)

6N: 6-Nylon of Tg: 48° C. (AMMAN CM101T, produced by Toray Industries, Inc.)

MXD6: RENY1002F (Tg: 75° C., produced by Mitsubishi Gas Chemical Corp.)

(D) Component

TAN1: A 1:1 mixture of Ph and PPS

TAN2: A 2:1 mixture of Ph and PPS

PPS: Polyphenylene sulfide (TORELINA of a Tg of 283° C., produced by Toray Industries, Inc.)

PI: A polyimide resin (PETI330, produced by Ube Industries, ltd.)

Ph: A phenol resin (novolac-type phenol resin PR-12687 of a Tm of 78° C., powder, produced by Sumitomo Bakelite Co., Ltd.)

(E) Component

PEN: A polyethylene naphthalate resin pallet of an inherent viscosity of 1.1 dl/g (produced by Teijin Chemicals Ltd.) having a melting point and a glass transition temperature (Tg) of 269° C. and 113° C., respectively, based on the same DSC method as described above

Kneader:

As a kneader, biaxial extrusion kneader KTX30 fitted with a decompression vent (produced by Kobe Steel, Ltd.) was used. The cylinder section of this apparatus incorporates 9 blocks of C1-C9 with respect to each temperature control block. A raw material supply opening was placed in the C1 block. The rotor and the screw of the kneader were arranged in combination in the C3 section and the C7 section, and a vent was placed in the C8 section. Further, the ejection opening was used with an attached predetermined die. In the case of use of any die, the kneader was used under the following conditions.

Cylinder setting temperature: C1-C2/C3-C9/die=120/220/260° C.

Screw rotational number: 250 rpm

Die A1: A die having gap sections at 3 locations shown in FIG. 2

Accumulation section 1a: maximum height h₁=10 mm, maximum cross-sectional area S₁ₐ=10 cm², moving direction distance m₁=20 mm

Gap 2a: interplanar distance x₁=1 mm, cross-sectional area S₂ₐ=6 cm², moving direction distance y₁=30 mm, width direction distance z₁=300 mm

Accumulation section 1b: maximum height h₂=10 mm, maximum cross-sectional area S_{1b}=30 cm², moving direction distance m₂=20 mm

Gap 2b: interplanar distance x₂=1 mm, cross-sectional area S_{2b}=6 cm², moving direction distance y₂=30 mm, width direction distance z₂=300 mm

Accumulation section 1c: maximum height h₃=10 mm, maximum cross-sectional area S_{1c}=30 cm², moving direction distance m₃=20 mm

Gap 2c: interplanar distance x₃=1 mm, cross-sectional area S_{2c}=6 cm², moving direction distance y₃=30 mm

Combined production was carried out using the above components, and the contents of resins whose performance was evaluated are shown below.

In Table 1 shown below, the numerical values of the (A) component-(E) component are expressed in % by mass.

TABLE 1

| | (A)Com- | (B)Com- | (C)Com- | (D)Com- | (E)Com- | (A)Com- | (B)Com- | (C)Com- | (D)Com- |
|---|---|---|---|---|---|---|---|---|---|
| | ponent | ponent | ponent | ponent | ponent | ponent | ponent | ponent | ponent |
| ** 1 | 51 | 29 | 14 | 5 | 1 | R-PET | PC1 | PAAV | PI |
| ** 2 | 80 | 10 | 6 | 3 | 1 | R-PET | PC1 | PAAV | TAN1 |
| ** 3 | 51 | 40 | 5 | 2 | 2 | PET | PC1 | PAAV | PPS |
| ** 4 | 55 | 10 | 30 | 4 | 1 | PET | PC1 | PAAV | TAN1 |
| ** 5 | 60 | 18 | 10 | 2 | 10 | R-PET | PC2 | COM4 | TAN1 |
| ** 6 | 70 | 10 | 15 | 0.5 | 4.5 | R-PET | PC2 | COM4 | Ph |
| ** 7 | 75 | 10 | 8 | 2 | 5 | R-PET | PC2 | COM1 | TAN1 |
| ** 8 | 77 | 10 | 8 | 1 | 4 | PET | PC1 | COM1 | Ph |
| ** 9 | 74 | 15 | 7 | 1 | 3 | PET | PC1 | COM2 | Ph |
| ** 10 | 69 | 16 | 10 | 1 | 4 | PET | PC1 | COM1 | Ph |
| ** 11 | 75 | 10 | 8 | 2 | 5 | PET | PC1 | COM3 | TAN2 |
| ** 12 | 77 | 10 | 8 | 1 | 4 | PET | PC1 | COM1 | TAN2 |
| ** 13 | 74 | 15 | 7 | 1 | 3 | PET | PC1 | COM1 | TAN2 |
| Comp. 1 | 60 | 25.6 | 4 | 0.4 | 10 | R-PET | PC2 | PAAV | TAN2 |
| Comp. 2 | 50 | 28 | 6 | 6 | 10 | R-PET | PC2 | PAAV | TAN2 |
| Comp. 3 | 85 | 7 | 5 | 2 | 1 | PET | PC1 | PAAV | TAN1 |
| Comp. 4 | 45 | 12 | 30 | 5 | 8 | PET | PC1 | PAAV | TAN1 |
| Comp. 5 | 77 | 6 | 4 | 5 | 8 | PET | PC1 | PAAV | PI |
| Comp. 6 | 51 | 10 | 33 | 5 | 1 | PET | PC1 | PAAV | PPS |
| Comp. 7 | 80 | 4 | 7 | 1 | 8 | R-PET | PC1 | PAAV | TAN1 |
| Comp. 8 | 50 | 41 | 5 | 1 | 3 | R-PET | PC1 | PAAV | TAN1 |
| Comp. 9 | 74 | 14 | 7 | 4.5 | 0.5 | R-PET | PC1 | PAAV | TAN1 |
| Comp. 10 | 60 | 21 | 7 | 1 | 11 | R-PET | PC1 | PAAV | TAN1 |
| Comp. 11 | 74 | 15 | 7 | 1 | 3 | R-PET | PC1 | St | TAN1 |
| Comp. 12 | 74 | 15 | 7 | 1 | 3 | R-PET | PC1 | 6N | TAN1 |
| Comp. 13 | 74 | 15 | 7 | 1 | 3 | R-PET | PC1 | MXD6 | TAN1 |

**: Example,
Comp.: Comparative Example

### Examples/Comparative Examples

The components shown in Table 1 were thy-blended at predetermine mass fractions using a V-type mixer. Then, the resulting mixture was dried under reduced pressure at 100° C. for 4 hours using a vacuum dryer. The thus-dried mixture was poured in from the raw material supply opening of the biaxial kneader and melt-kneaded under a condition of an ejection amount of 30 kg/hour and a resin pressure of 4 MPa. For details, a resin composition having been ejected from the biaxial kneader was allowed to flow into a predetermined die from the inflow opening in the melted state, followed by passing through a predetermined gap section to be ejected from the ejection opening. The kneaded material having been ejected from the die was immersed in water of 30° C. for rapid cooling and then pulverized into a pellet shape using a pelletizer to give a resin composition.

<Performance Evaluation>

(1) Mechanical Physical Properties of Resin Compositions

A pellet-shaped resin composition was dried at 100° C. for 4 hours, and thereafter, a stripe-shaped specimen of 100 mm×10 mm×4 mm was molded at a cylinder setting temperature of 280° C. and a die temperature of 40° C. using an injection molding machine (J55ELII, produced by Japan Steel Works, Ltd.). With regard to the specimen, a Charpy impact test (U notch, R=1 mm) was carried out based on JIS-K7111, and a bending test was carried out based on JIS-K7171. Elastic modulus was determined from the result of the initial strain in the bending test. The evaluation criteria are listed below.

Bending Test

At least 82 MPa: extremely excellent

70 MPa-less than 82 MPa: highly excellent

66 MPa-less than 70 MPa: excellent

50 MPa-less than 66 MPa: practically non-problematic

Less than 50 MPa: practically problematic

Elastic Modulus

At least 3.0 GPa: extremely excellent

2.7 GPa-less than 3.0 GPa: highly excellent

2.1 GPa-less than 2.7 GPa: excellent

2.0 GPa-less than 2.1 GPa: practically non-problematic

Less than 2.0 GPa: practically problematic

Charpy Impact Test

At least 62 kJ/m²: extremely excellent

42 kJ/m²-less than 62 kJ/m²: excellent

32 kJ/m²-less than 42 kJ/m²: good

6 kJ/m²-less than 32 kJ/m²: practically non-problematic

Less than 6 kJ/m²: practically problematic

(2) Flame-Retardant Performance Test

The same kneader as the above kneader was used except that the die was replaced with a strand die. For details, a pellet-shaped resin composition was dried at 100° C. for 4 hours, and then extruded into a strand shape using the kneader, followed by cooling. The strand was cut into a 10 cm long piece and then the thus-obtained sample was inclined at an angle of 45 degrees. The portion having a distance of 1 cm from the end portion was fixed to be ignited with a lighter. Ranking was made based on the following criteria.

A: Flame self-extinction was realized at a burning distance of less than 0.3 cm and the burned portion was less than 0.3 cm; highly excellent

B: Flame self-extinction was realized at a burning distance of less than 2 cm and the burned portion was 0.3 cm-less than 2 cm; excellent

C: Flame self-extinction was realized at a burning distance of less than 5 cm and the burned portion was 2 cm less than 5 cm; practically non-problematic

D: No flame self-extinction was realized even at a burning distance of less than 5 cm and the burned portion was at least 5 cm; practically problematic

(3) Appearance

The entire appearance/surface state of a molded flame-retardant polyester resin composition specimen was evaluated.

TABLE 2

| | Bending | Elastic | Impact | Flame- | |
|---|---|---|---|---|---|
| | Strength | Modulus | Strength | Retardant | |
| | (MPa) | (GPa) | (kJ/m²) | Performance | Appearance |
| Example 1 | 87 | 3.2 | 48 | A | excellent |
| Example 2 | 58 | 2.8 | 36 | A | excellent |
| Example 3 | 57 | 3.4 | 38 | A | excellent |
| Example 4 | 62 | 2.9 | 65 | A | excellent |
| Example 5 | 60 | 3.1 | 57 | A | excellent |
| Example 6 | 61 | 2.8 | 60 | A | excellent |
| Example 7 | 58 | 2.9 | 35 | A | excellent |
| Example 8 | 61 | 2.7 | 42 | A | excellent |
| Example 9 | 59 | 2.9 | 38 | A | excellent |
| Example 10 | 60 | 2.8 | 39 | A | excellent |
| Example 11 | 59 | 2.6 | 32 | A | excellent |
| Example 12 | 58 | 2.7 | 31 | A | excellent |
| Example 13 | 61 | 2.9 | 58 | A | excellent |
| Comparative | 21 | 2.9 | 9 | D | excellent |
| Example 1 | | | | | |
| Comparative | 20 | 3.1 | 8 | D | excellent |
| Example 2 | | | | | |
| Comparative | 19 | 2.8 | 3 | D | uneven |
| Example 3 | | | | | |
| Comparative | 32 | 2.1 | 38 | D | excellent |
| Example 4 | | | | | |
| Comparative | 18 | 2.6 | 6 | D | excellent |
| Example 5 | | | | | |
| Comparative | 20 | 3.2 | 10 | D | uneven |
| Example 6 | | | | | |
| Comparative | 28 | 2.1 | 16 | D | uneven |
| Example 7 | | | | | |
| Comparative | 22 | 2.8 | 9 | D | uneven |
| Example 8 | | | | | |
| Comparative | 24 | 2.1 | 11 | D | uneven |
| Example 9 | | | | | |
| Comparative | 23 | 2.7 | 8 | D | uneven |
| Example 10 | | | | | |
| Comparative | 28 | 2.5 | 8 | C | uneven |
| Example 11 | | | | | |
| Comparative | 30 | 2.4 | 11 | C | uneven |
| Example 12 | | | | | |
| Comparative | 31 | 2.7 | 12 | C | uneven |
| Example 13 | | | | | |

The above evaluation results confirm that all the characteristics of Examples 1-13 within the present invention are excellent but at least any of the characteristics of Comparative Examples 1-13 out of the present invention is problematic.

### DESCRIPTION OF THE SYMBOLS

1a, 1b, 1c: accumulation section
2a, 2b, 2c: gap
5: inflow opening
6: ejection opening
10A, 10B, 10C, 10D: resin composition production apparatus

What is claimed is:

1. A flame-retardant polyester resin composition comprising
(A) 50-80% by mass of a polyethylene terephthalate (PET),
(B) 5-40% by mass of a polycarbonate resin,
(C) 5-30% by mass of a polymer of a glass transition temperature Tg of less than 35° C.,
(D) 0.5-5% by mass of a polymer of a carbon residue rate of at least 15%, and
(E) 1-10% by mass of a polyethylene naphthalate (PEN).

2. The flame-retardant polyester resin composition of claim 1, wherein the polyethylene terephthalate is recycled from a discarded polyester resin product in a shape of a size of 30 mm or less through removing a foreign material, pulverizing and washing steps.

3. The flame-retardant polyester resin composition of claim 1, wherein the polycarbonate resin is recycled from a discarded polycarbonate resin product in a shape of a size of 30 min or less through removing a foreign material, pulverizing and washing steps.

4. The flame-retardant polyester resin composition of claim 1, wherein the polymer mixture comprising the components (A)-(E) of the melt state is passed through the gap of 2 parallel flat planes having an interplanar distance x of at most 5 mm.

5. A method for producing the flame-retardant polyester resin composition of claim 1, wherein the polymer mixture comprising the components (A)-(E) of the melt state is passed through the gap of 2 parallel flat planes having an interplanar distance x of at most 5 mm.
